(19) United States
(12) Patent Application Publication
(10) Pub. No.: US 2016/0180255 A1
(43) Pub. Date: Jun. 23, 2016

(54) METHOD AND SYSTEM FOR MANAGING AIRPORT BAGGAGE

(71) Applicant: Unisys Corporation, Blue Bell, PA (US)

(72) Inventor: Floor Goedemondt, Schiphol-Rijk (NL)

(21) Appl. No.: 14/580,337

(22) Filed: Dec. 23, 2014

(51) Int. Cl. G06Q 10/00

(52) U.S. Cl. CPC G06Q 10/00

(57) ABSTRACT

A system and method for managing airport customer baggage. The system includes a business logic module, a user interface coupled to the business logic module that allows an end user to communicate and interact with the business logic module, a logging module coupled to the business logic module for maintaining logging information for the baggage management system, a configuration module coupled to the business logic module for maintaining configuration parameters for the baggage management system, a reporting module coupled to the business logic module for generating reports associated with the baggage management system, a host connectivity module coupled to the business logic module for managing the connectivity between the baggage management system and a plurality of different hosts, and a security module coupled to the business logic module for authenticating and authorizing an end user of the baggage management system.

### BACKGROUND

1. Field

The instant disclosure relates generally to airport baggage handling systems, and more particularly, to methods and systems for managing airport baggage drop off processes.

2. Description of the Related Art

Most airports throughout the world typically host and support a plurality of different airlines, thereby offering airport customers the ability to fly with any one of a number of different airlines. Within most airports, each airline at the airport typically has its own customer baggage management and processing system, whereby the baggage of each airline customer brought to the airport can be dropped off, managed and processed for transport with the customer on the customer's flight. The airport typically has an overall or central baggage management and processing system for physically maneuvering the customer baggage of each airline to the appropriate locations within the airport. The baggage management and processing system of each airline at the airport should be able to communicate with the airport's central baggage management and processing system with respect to the physical handling of the baggage of that particular airline. However, with regard to front end interfacing between airport customers and each individual airline, each airline maintains its own baggage management and processing system, with little if any interfacing with other airline baggage management and processing systems or with the airport's central baggage management and processing system.

### SUMMARY

Disclosed is a system and method for managing airport customer baggage. The system includes a business logic module, a user interface coupled to the business logic module that allows an end user to communicate and interact with the business logic module, a logging module coupled to the business logic module for maintaining logging information for the baggage management system, a configuration module coupled to the business logic module for maintaining configuration parameters for the baggage management system, a reporting module coupled to the business logic module for generating reports associated with the baggage management system, a host connectivity module coupled to the business logic module for managing the connectivity between the baggage management system and a plurality of different hosts, and a security module coupled to the business logic module for authenticating and authorizing an end user of the baggage management system.

### BRIEF DESCRIPTION OF THE DRAWINGS

FIG. 1 is a schematic view of a baggage management and processing system, according to an embodiment;

FIG. 2 is a schematic view of the methods used by a reporting module within the baggage management and processing system, according to an embodiment;

FIG. 3 is a schematic view of a host connectivity module within the baggage management and processing system, according to an embodiment;

FIG. 4 is a sequence diagram for a passenger host transaction involving the baggage management and processing system, according to an embodiment;

FIG. 5 is a schematic view of a device interface for use with one or more devices within the baggage management and processing system, according to an embodiment; and

FIG. 6 is a schematic view of an environment in which the baggage management and processing system is used, according to an embodiment.

### DETAILED DESCRIPTION

In the following description, like reference numerals indicate like components to enhance the understanding of the disclosed methods and systems through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the disclosure.

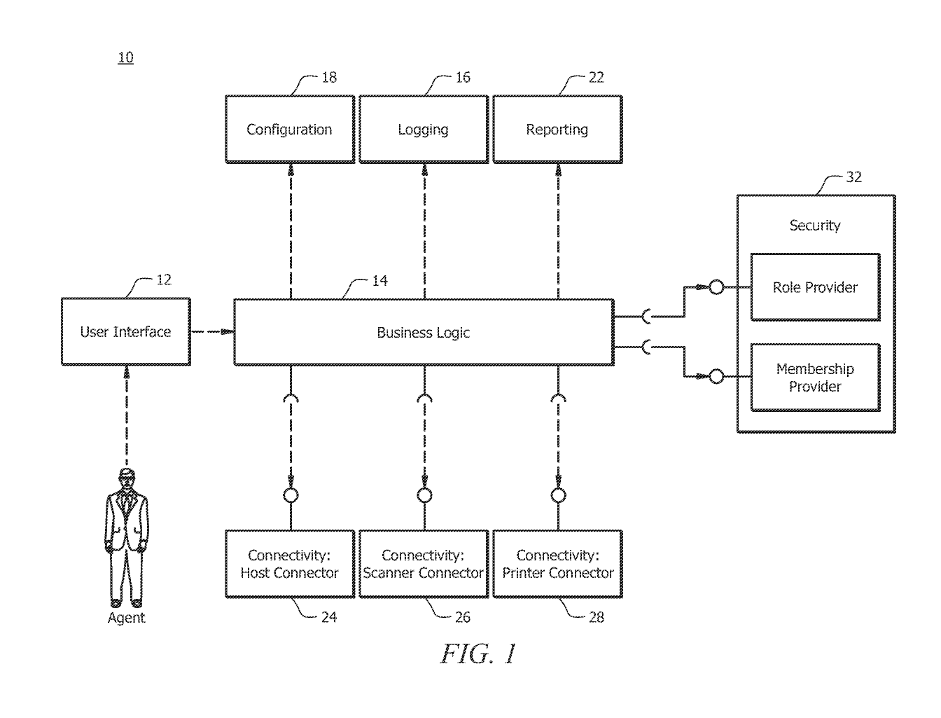

FIG. 1 is a schematic view of a baggage management and processing system 10, according to an embodiment. The baggage management and processing system 10 is an application that assists an end user, e.g., airport ground personnel, in the customer baggage drop off process. The baggage management and processing system 10 can be run on any suitable processing platform or system, e.g., a Microsoft Windows environment. The baggage management and processing system 10 typically connects to a number of external devices, as will be discussed in greater detail hereinbelow. The manner in which the baggage management and processing system 10 connects to external devices can differ per location, and involves the infrastructure elements of the local service provider.

The baggage management and processing system 10 includes a user interface 12, a business logic module 14, a logging module 16, a configuration module 18 and a reporting module 22. The baggage management and processing system 10 also includes one or more connectivity modules, e.g., a host connectivity module 24, a scanner connectivity module 26 and a printer connectivity module 28. The connectivity baggage management and processing system 10 also includes a security (authentication and authorization) module 32.

The user interface 12 is a graphical user interface or other suitable interface that allows interaction between the baggage management and processing system 10 and an end user. The user interface 12 is coupled to the business logic module 14. The user interface 12 can be based on any suitable processing platform, e.g., Microsoft Windows Presentation Foundation (WPF), or other suitable graphical subsystem for rendering the user interface 12. The user interface 12 can be multilingual and contain a number of different languages in addition to English.

The business logic module 14 is one of the main processing modules or components in the connectivity baggage management and processing system 10. The business logic module 14 includes logic for the operation of the baggage management and processing system 10, and connects to all of the other major modules or components of the baggage management and processing system 10. As will be discussed in greater detail hereinbelow, the business logic module 14 handles the operations for the many of the application activities of the baggage management and processing system 10. Typically, the business logic module 14 is the only module with whom the user interface 12 communicates.

The logging module 16 is coupled to the business logic module 14. The logging module 16 performs error logging, warning logging, various information logging, and debug logging functions.

The configuration module 18 also is coupled to the business logic module 14. The configuration module 18 includes the main configuration parameters for the baggage management and processing system 10. The configuration parameters typically are stored as one or more configuration files, in any suitable format, e.g., an extensible markup language (XML) format. The path to the configuration files is passed on as a start-up parameter to the baggage management and processing system 10. An administrator end user can modify the configuration files, as local access to the configuration files may not be possible. The configuration files can include one or more configuration items, e.g., a distributed control system (DCS) host configuration file location per airline, default free baggage calculation information per airline, and a frequent flyer tier table per airline.

The reporting module 22 also is coupled to the business logic module 14. Reporting is used by the owner/operator of the baggage management and processing system 10 for many purposes, including billing and diagnostic purposes. There are two main methods for reporting: online reporting and offline reporting. Typically, the reporting module 22 first tries the online reporting method, and falls back to the offline reporting method if no connection can be established with the reporting server via the online reporting method.

The security module 32 is coupled to the business logic module 14. The security module 32 includes one or more forms of authentication and authorization for an end user. End users are authenticated by the security module 32 in any suitable manner, e.g., by an end user providing the security module 32 with a username and appropriate password. The information provided by an end user to the security module 32 is validated by the security module 32 against user information within a user database that is part of or coupled to security module 32. In addition to the user database holding user information, the user database also maintains authorization profiles for each end user. These authorization profiles contain information on what types of actions or roles the end user is allowed to perform within the baggage management and processing system 10. For example, the most basic forms of actions or roles for an end user include a User role and an Administrator role.

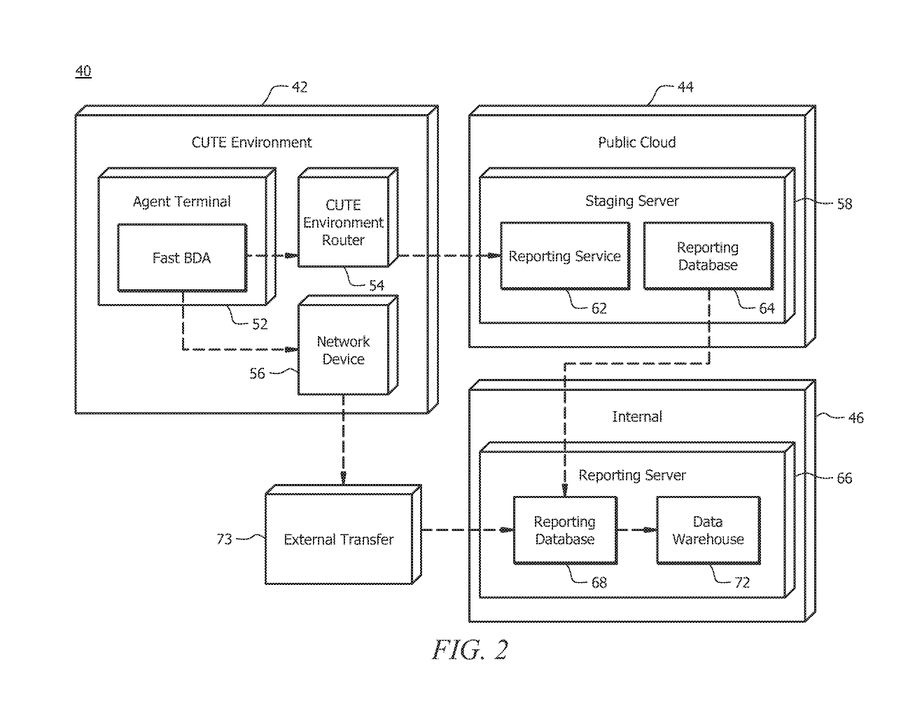

FIG. 2 is a schematic view of the methods 40 used by the reporting module 22 within the baggage management and processing system 10, according to an embodiment. The methods 40 include a number of execution environments, including a CUTE (constrained and unconstrained testing environment) environment 42, a public cloud environment 44, and an internal environment 46.

The CUTE environment 42 includes a number of devices, including an agent terminal device 52, a CUTE environment router device 54 and a network device 56. The public cloud environment 44 includes a staging server device 58, which includes a reporting service module 62 and a reporting database 64. The internal environment 46 includes a reporting service module 62 and a reporting database 64. The internal environment 46 includes a reporting server device 66, which includes a reporting database 68 and a data warehouse 72. An external transfer module 73 is coupled between the network device 56 in the CUTE environment 42 and the reporting database 68 in the internal environment 46.

A single report typically includes transaction information and diagnostic information. Transactional information can include an electronic ticket (E-ticket) number, the number of bags being dropped off, the flight number, the airline, the airport, a timestamp, the workstation name, a sequence number (which is incremental per workstation), the agent name and a transaction GLAD (Globally Unique Identifier). Diagnostic information can include timings and errors.

The sequence number in combination with the workstation name can be used to detect gaps in the reports. Reports sent from the baggage management and processing system 10 via either the online reporting method or the offline reporting method typically are encrypted and/or protected against modifications.

In an online reporting scenario, each transaction is (or a list of transactions are) reported to an online reporting service. The online reporting service is hosted by an appropriate operator/owner of the baggage management and processing system 10. Usage reports typically are encrypted before being sent to the online reporting service. The online reporting service decrypts the received information and validates the information contained therein. The encrypted reports are stored in a suitable database, e.g., a staging structured query language (SQL) database. Periodically (e.g., daily or weekly), the gathered data is transferred to an internal reporting server, where the gathered data typically is decrypted and processed, e.g., in a suitable SQL analysis service environment.

In an offline reporting scenario, each transaction is (or a list of transactions are) stored at a central location within a CUTE environment. Such environment can be a network shared drive or a local drive. Periodically, the provider sends the reporting information to the owner/operator of the baggage management and processing system 10. The received reporting information then is loaded into a suitable reporting server.

The reporting server can either pull reporting information from the staging server or import reporting information from the offline reporting files. In both situations, duplicate transactions can be detected by comparing transaction GUIDs that are present in both reports. The reporting methods can generate various reports, including airport desk usage reports, airport bag processing reports, and monthly billing reports.

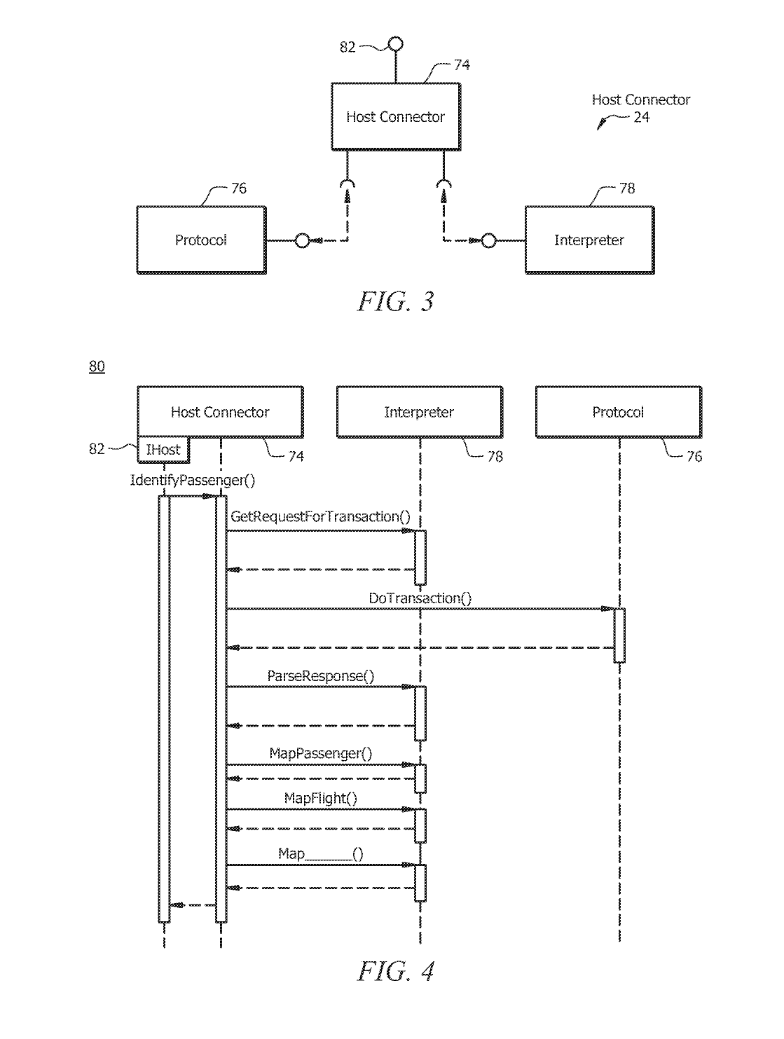

FIG. 3 is a schematic view of the host connectivity module 24 within the baggage management and processing system 10, according to an embodiment. The host connectivity module 24 includes a host connector module or object 74, a protocol module or object 76 and an interpreter module or object 78.

The baggage management and processing system 10 needs to communicate with a plurality of different hosts, such as DCS hosts, via a number of different CUTE environments. The connectivity to a DCS host is managed by the host connector module 74. The host connector module 74 is responsible for the implementation of an IHost interface 82 that is used by the host connector module 74. The host connector module 74 controls what transactions are executed and in what order those transactions are executed. The host connector module 74 uses the interpreter module 78 to create transaction requests and to interpret the transaction responses. The actual transactions are sent to the various hosts using the protocol module 78.

The architecture or configuration of the host connectivity module 24 allows multiple combinations of protocols and interpreters for a single host connector module 74. For example, a host connector module 74 can be configured to use a protocol module for an Internet Protocol (IP) connection at one site, and a CUTE gateway protocol at a different site, without the need to change the configuration of the interpreter module 78 or the logic of the host connector module 74. Also, a derived interpreter module 78 can be used for the host connector module 74 if the host to which the host connector module 74 is connected is derived from the host for which the host connector module 74 was initially designed. In this case, the overall order of transactions is the same, but some fields might appear at different locations, or the transaction might include new fields.

According to an embodiment, the IHost interface 82 and its modules can be extended or configured to include more than bag drop functionality. For example, the IHost interface 82 and its modules can be extended or configured to include check-in functionality and/or passenger boarding functionality.

FIG. 4 is a sequence diagram 80 for a passenger host transaction involving the baggage management and processing system 10, according to an embodiment. The sequence diagram 80 shown is for an Identify Passenger host transaction. The roles of the interpreter module 78 and the protocol module 76 are described hereinbelow. In the sequence diagram 80, an event is triggered by a request from the baggage management and processing system 10 to the IHost interface 82 of the host connectivity module 24. In this example, the requested event is an IdentifyPassenger event.

The interpreter module 78 is the main component responsible for interfacing with a DCS host via host transactions. The interpreter module 78 creates host transaction requests and interprets their responses. The interpreter module 78 is based on a set of regular expressions that can be configured via its configuration file. The regular expressions match specific parts of the transaction response and map it to a “matchname”.

The information passed back to the host connector module 74 typically is a dictionary containing these matchnames and their matched data. The host connector module 74 uses this data to create a valid response that will be passed back to the baggage management and processing system 10 via the business logic module 14. The host connector module 74 can then call different helper methods on the interpreter module 78 to map the dictionary data to actual entities within the baggage management and processing system 10.

The actual communication with a DCS host is performed using the protocol module 76. The protocol module 76 accepts a host transaction and sends the host transaction to the DCS host. The response for that transaction is returned to the caller. The protocol module 76 is also involved with the encoding/decoding of outgoing and incoming messages, and the protocol module 76 makes sure that the baggage management and processing system 10 properly receives encoded strings, such as UTF-8 encoded strings.

The protocol module 76 also receives any host messages that are unsolicited. These unsolicited messages might contain host messages or print stream data. Both types of unsolicited messages are passed on to the host connector module 74 using events. These events include the content of the message and the source of the message.

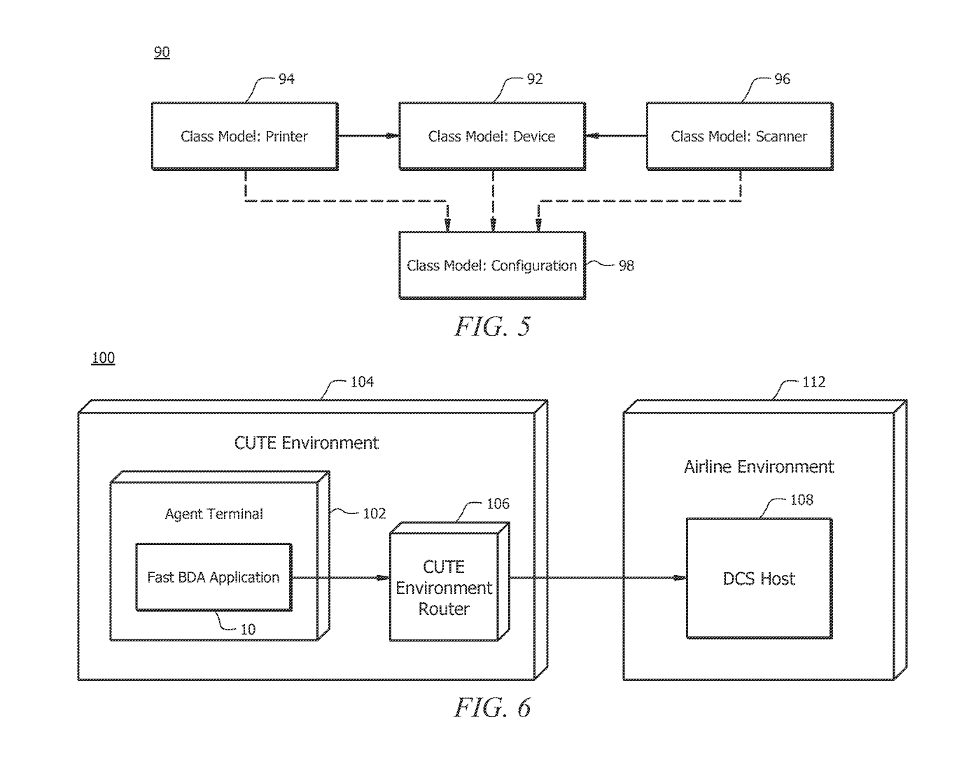

FIG. 5 is a schematic view of a device interface 90 for use with one or more devices within the baggage management and processing system 10, according to an embodiment. The device interface 90 can include a device module 92, a printer module 94, a scanner module 96 and a configuration module 98. The device interface 90 is coupled to the business logic 14 (FIG. 1). The device interface 90 is represented in FIG. 1 as the scanner connectivity module 26 and the printer connectivity module 28. The device interface 90 allows for the configuring of different device modules whereby the device modules are compatible (and certified) on multiple CUTE platforms.

The device module 92 defines the methods and events that are required to communicate with various devices that are coupled to or are part of the baggage management and processing system 10.

The printer module 94 defines the methods and events that are required to communicate with various printer devices that are coupled to or are part of the baggage management and processing system 10. The printer module 94 can be coupled to or a part of the printer connectivity module 28,

The scanner module 96 defines the methods and events that are required to communicate with various scanner devices that are coupled to or are part of the baggage management and processing system 10. The scanner module 96 can be coupled to or a part of the scanner connectivity module 26.

FIG. 6 is a schematic view 100 of the environment in which the baggage management and processing system 10 is used, according to an embodiment. As shown, the baggage management and processing system 10 can be deployed within an agent terminal 102. The agent terminal 102 is deployed within a CUTE environment 104, and is coupled to a CUTE environment router 106, which also is deployed within the CUTE environment 104. The CUTE environment router 106 is connected to one or more DOS hosts 108, which are deployed within an airline environment 112.

Referring again to FIG. 1, the business logic module 14 includes one or more general purpose (host) controllers or processors that, in general, processes instructions, data and other information in the baggage management and processing system 10. The business logic module 14 also manages the movement of various instructional or informational flows between various modules and components within the baggage management and processing system 10. The business logic module 14 is configured to execute and perform one or more of the baggage management and processing steps described herein.

The business logic module 14 also can include a memory element or content storage element (not shown), coupled to the business logic module 14, for storing instructions, data and other information received and/or created by the business logic module 14. In addition to a memory element, the business logic module 14 can include at least one type of memory or memory unit (not shown) within the business logic module 14 for storing processing instructions and/or information received and/or created by the business logic module 14.

One or more of the modules and components in the baggage management and processing system 10 can be comprised partially or completely of any suitable structure or arrangement, e.g., one or more integrated circuits. Also, one or more of the modules and components in the baggage management and processing system 10 can be partially or completely configured in the form of hardware circuitry and/or other hardware components within a larger device or group of components. Also, it should be understood that the baggage management and processing system 10 includes other components, hardware and software (not shown) that are used for the operation of other features and functions of the system not specifically described herein.

One or more of the modules and components in the baggage management and processing system 10 can be implemented in hardware, firmware, or any combination thereof. In certain embodiments, the module(s) may be implemented in firmware that is stored in a memory and/or associated components and that are executed by the business logic module 14 or other appropriate module or component in the baggage management and processing system 10. One of ordinary skill in the art will appreciate that any process or method descriptions associated with the baggage management and processing system 10 may represent modules, segments, logic or portions of code which include one or more executable instructions for implementing logical functions or steps in the process. It should be further appreciated that any logical functions may be executed out of order from that described, including substantially concurrently or in reverse order, depending on the functionality involved, as would be understood by those reasonably skilled in the art. Furthermore, the modules may be embodied in any non-transitory computer readable medium for use by or in connection with an instruction execution system, apparatus, or device, such as a computer-based system, processor-containing system, or other system that can fetch the instructions from the instruction execution system, apparatus, or device and execute the instructions.

The functions described herein may be implemented in hardware, firmware, or any combination thereof. The methods illustrated in the figures may be implemented in a general, multi-purpose or single purpose processor. Such a processor will execute instructions, either at the assembly, compiled or machine-level, to perform that process. Those instructions can be written by one of ordinary skill in the art following the description of the figures and stored or transmitted on a non-transitory computer readable medium. The instructions may also be created using source code or any other known computer-aided design tool. A non-transitory computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), and the like.

It will be apparent to those skilled in the art that many changes and substitutions can be made to the embodiments described herein without departing from the spirit and scope of the disclosure as defined by the appended claims and their full scope of equivalents,

1. A baggage management system, comprising:
a business logic module;
a user interface coupled to the business logic module, wherein the user interface allows an end user to communicate and interact with the business logic module;
a logging module coupled to the business logic module, wherein the logging module maintains logging information for the baggage management system;
a configuration module coupled to the business logic module, wherein the configuration module maintains configuration parameters for the baggage management system;
a reporting module coupled to the business logic module, wherein the reporting module generates reports associated with the baggage management system;
a host connectivity module coupled to the business logic module, wherein the host connectivity module manages the connectivity between the baggage management system and a plurality of different hosts; and
a security module coupled to the business logic module, wherein the security module authenticates and authorizes an end user of the baggage management system.

2. The system as recited in claim 1, wherein the host connectivity module includes a host connector module, a protocol module and an interpreter module.

3. The system as recited in claim 2, wherein the host connector module uses the interpreter module to create and interpret transaction requests and responses, and wherein the host connector module uses the protocol module to send transactions to one or more of the hosts.

4. The system as recited in claim 1, wherein the host connectivity module is configured to use a plurality of different protocols and interpreters without the need to change the configuration of the of the interpreter module or the logic of the host connector module.

5. The system as recited in claim 1, further comprising at least one device connectivity module coupled to the business logic module for managing the methods and events to communicate with a corresponding device coupled to the baggage management system.

6. The system as recited in claim 5, wherein the device connectivity module comprises at least one of a device connectivity module, a scanner connectivity module and a printer connectivity module.

7. The system as recited in claim 1, wherein the reporting module generates a transaction information report including at least one of an electronic ticket number, the number of bags being dropped off, the flight number, the airline, the airport, a timestamp, the workstation name, a sequence number, the agent name and a transaction Globally Unique Identifier (GUM.

8. The system as recited in claim 1, wherein the reporting module generates a diagnostic information report including timings and errors.

9. The system as recited in claim 1, wherein the reporting module is configured to execute at least one of online reporting and offline reporting.

10. A method for operating a baggage management system, comprising:
allowing an end user to communicate and interact with the baggage management system;
maintaining logging information for the baggage management system;
maintaining configuration parameters for the baggage management system;
generating reports associated with the baggage management system;
managing the connectivity between the baggage management system and a plurality of different hosts;
authenticating an end user of the baggage management system; and
authorizing an end user of the baggage management system.
